(19) United States
(12) Patent Application Publication
(10) Pub. No.: US 2006/0099057 A1
(43) Pub. Date: May 11, 2006

(54) Selectively adjustable automobile storage device

(76) Inventor: Paul Fair, Denver, CO (US)

Correspondence Address: SHERIDAN ROSS PC, 1560 BROADWAY, SUITE 1200, DENVER, CO, 80202, US

(21) Appl. No.: 11/190,258

(22) Filed: Jul. 26, 2005

Related U.S. Application Data
(60) Provisional application No. 60/591,502, filed on Jul. 26, 2004.

(51) Int. Cl. B65F 3/02

(52) U.S. Cl. 414/408

(57) ABSTRACT

A flexible folding storage device is provided that includes a first triangular section hingedly interconnected to a second triangular section, thus providing the user with the ability to customize the storage area depending on amount and size of space that is required for storage of items. The triangular sections can be configured to create a storage system in the form of any one of a rectangle, a larger rectangle, a triangle, two independent triangles, or a triangle that is larger than either of the previously mentioned triangles. Both triangular sections can be optionally collapsed so that no extra space is used when a storage device is not necessary.

This application claims the benefit of U.S. Provisional Patent Application Ser. No. 60/591,502, filed Jul. 26, 2004, which is incorporated by reference in its entirety herein.

### FIELD OF THE INVENTION

The present invention relates to an automotive accessory item and more specifically, to a dynamic storage solution for compact discs, electronic devices, school supplies, office accessories, and other items commonly transported in a vehicle.

### BACKGROUND OF THE INVENTION

With the increasing amount of time that individuals spend commuting, traveling, and otherwise utilizing motor vehicles, there is a need for efficiently providing item storage. More specifically, individuals want to carry more in a given space, and so it has become more important to find new ways of organizing commonly used items. The need to organize is not limited to cars, trucks, vans, or SUVs. Organization of goods in small spaces is also desirable in the home, for example in the laundry room or kitchen of a house. It is also beneficial to be able to organize children's toys, putting a number of their toys into a “toy-box”.

In addition, many salesmen and other business people use their vehicles as a form of traveling office wherein numerous files, supplies, etc. are often used that also require efficient storage to reduce clutter and provide organization. Further, children require school materials that need to be carried to and from school perhaps in a truck, van, car, or SUV, and all of these materials require additional storage space in the already limited, interior space of a vehicle.

There exists many storage devices that generally meet the need of storing a number of items in a small space. However, most of the storage devices of the other prior art have one shape, are rigid, and/or do not provide a dynamic capability that allows for storage space customization. For example, rigid storage devices for use in a vehicle are known in the art and occur in a variety of shapes. However, these storage devices may be well suited for the current vehicle being used, but are ill suited for a newly purchased vehicle that may have drastically different areas for storage to accommodate the older storage device.

With storage space being a premium and people wanting to carry additional items in their vehicle, it is necessary to have an adaptable storage device to keep items from shifting while the vehicle is in motion. People also require and desire a storage device that secures items in a single position, not allowing the items to roll around risking breakage or damage to the interior of a vehicle. Owners of trucks specifically may want storage in the bed of their truck and do not wish either tools or other items roll around in the back of their truck.

Another problem associated with most existing vehicle storage devices is that they are often constructed of rigid materials. These storage devices may pose a health risk to riders inside a vehicle if the storage device becomes a projectile, for example, in an accident. Also, children may fall against or into rigid devices and injure themselves on a hard corner thereof.

As is mentioned above, many items now address this problem of storage and securing items in the bed of trucks, the back of a car, the trunk of the car, or the back of an SUV or van, but these existing products do not provide dynamic capabilities of opening to accommodate more items. In addition, they do not allow the users to selectively collapse sections of the storage device.

### SUMMARY OF THE INVENTION

The aforementioned and other needs are addressed by the various embodiments and configurations of the present invention. The present invention is directed generally to a selectively adjustable storage device. The storage device includes a first triangular volume hingedly interconnected to a second triangular volume. Both of the triangular volumes may include a hook and loop material or other interconnecting devices placed on the bottom surfaces thereof to help the storage device remain stationary during travel. Alternatively, one embodiment of the present invention omits bottom surfaces.

In a first closed state the two triangular volumes are brought together to form a rectangular volume, or in a preferred configuration, a cube. In one configuration the free ends of the first triangular volume and second triangular volume are fastened together by a latching mechanism to maintain the shape of the storage device. The latching mechanism can also be loop and hook material, a button, a snap, or any other connecting means known in the art.

The latching mechanisms can also serve the purpose of securing the storage device to the interior of the car, thus ensuring the storage device does not become a dangerous projectile in the event of an accident. Furthermore, the first and second triangular volumes are made of a conforming material in one embodiment, which also ensures the safety of passengers or other people that may be around the storage device.

In another configuration, the free ends of the first triangular volume and the second triangular volume are not secured, where the angle between the previously adjoined surfaces is greater than about 0° but less than about 180°. Rather they are separated by a distance to allow the storage device to change shape from the previously mentioned square or rectangle to a larger rectangle or square. Between the previously adjoined surfaces exists an open cavity generally in the shape of a triangle, thereby allowing for further storage space than either triangular volume could supply alone. In this configuration a material can be positioned between the triangular volumes across the cavity formed therein to supply further storage space. This material can be mesh or transparent to allow users to see the contents inside of the cavity.

In yet another configuration the triangular volumes of the embodiment are positioned such that the angle between the previously adjoining surfaces is substantially 180°. In this configuration, the previously adjoining surfaces can be placed against a wall or some other generally flat surface and a triangular cavity that is different from the above-mentioned triangular cavity is formed. Again, a material may be provided that spans the distance between the two triangular volumes across the newly formed triangular cavity to facilitate further storage than either triangular volume could supply previously.

In a further configuration, the first triangular volume backs up to the second triangular volume to create a triangular storage device that has as much storage space as the above-mentioned configuration where the open ends were connected to form a rectangle or square. The previously adjoining surfaces are now at an angle to each other that exceeds 180°. In this configuration the storage device can be placed in the corner of a vehicle's trunk or the corner of a room such that more storage space is located closer to the wall or extremities of the vehicle and allows for more room in the area away from the walls.

It is another aspect of the present invention that the first triangular volume can be open at the top or selectively closable be either an open storage compartment or a closed storage compartment. Having the first and second triangular volumes be either open or closed or a combination thereof allows the user to store objects that may be taller or shorter than the triangular volume is alone. Having a closed storage device provides added security that loose objects will not fall out of the storage device if the storage device suddenly tips over. In one embodiment, a zipper is used to secure a cover onto the triangular storage volume. The sealing means of the closed storage means can also be a hook and loop material, a series of snaps, etc.

In still a further aspect of the present invention one or both of the triangular volumes can be collapsed when they are not utilized for storage. If both triangular volumes are not needed for storage, one of the sides can collapse to create more room for other objects in the vehicle or room. Also, if the storage device is not needed at a particular time then both triangular volumes can be collapsed such that no excess space is used by the storage device.

In yet another embodiment of the present invention, one or both of the triangular volumes can constructed of an insulated material. In addition, the insulating material may be either a conformable material or a rigid material. The insulated volumes could create a cooler to keep food and drinks cold or hot.

Thus, it is one aspect of the present invention to provide an adjustable storage device, comprising:

a first volume defined by three generally vertical faces interconnected to form a prismatic shape having three vertical edges;

a second volume defined by three generally vertical faces interconnected to form a prismatic shape having three vertical edges, wherein an edge of said three vertical edges of said second volume is hingedly interconnected to an edge of said three vertical edges of said first volume; and

wherein an angle is formed between a face of said three generally vertical faces of said first volume and a face of said three generally vertical faces of said second volume said first volume and said second volume may be selectively oriented relative to each other to provide selective customization.

The Summary of the Invention is neither intended or should it be construed as being representative of the full extent and scope of the present invention. The present invention is set forth in various levels of detail and the Summary of the Invention as well as in the attached drawings and in the detailed description of the invention and no limitation as to the scope of the present invention is intended by either the inclusion or non inclusion of elements, components, etc. in the Summary of the Invention. Additional aspects of the present invention will become more readily apparent from the detailed description, particularly when taken together with the drawings.

### BRIEF DESCRIPTION OF THE DRAWINGS

The accompanying drawings which are incorporated in and constitute a part of the specification, illustrate embodiments of the invention and together with the general description of the invention given above and the detailed description of the drawings given below, serve to explain the principles of these inventions.

FIG. 1 is a perspective view of an adjustable storage device in a closed, rectangular configuration;

FIG. 2 is a perspective view of the adjustable storage device in an open, rectangular state;

FIG. 3 is a perspective view of the adjustable storage device in another open configuration; and

FIG. 4 is a perspective view of the adjustable storage device in a closed, triangular configuration.

The following components and numbers associated thereto are shown in the drawings and provided here for ease of reference:

| # | Component |
|---|---|
| 100 | Adjustable storage device |
| 102 | First Triangular volume |
| 104 | Second Triangular volume |
| 106 | Hinging Member |
| 108 | First Adjoining Surface |
| 110 | Second Adjoining Surface |
| 112 | Buckle |
| 114 | Latch |
| 116 | Closure pull |
| 118 | Zipper |
| 120 | First Handle |
| 122 | Second Handle |
| 124 | Enclosing surface |
| 126 | Angle α between Adjoining Surfaces |
| 128 | Pockets |
| 130 | First Triangular Storage Cavity |
| 132 | Second Triangular Storage Cavity |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

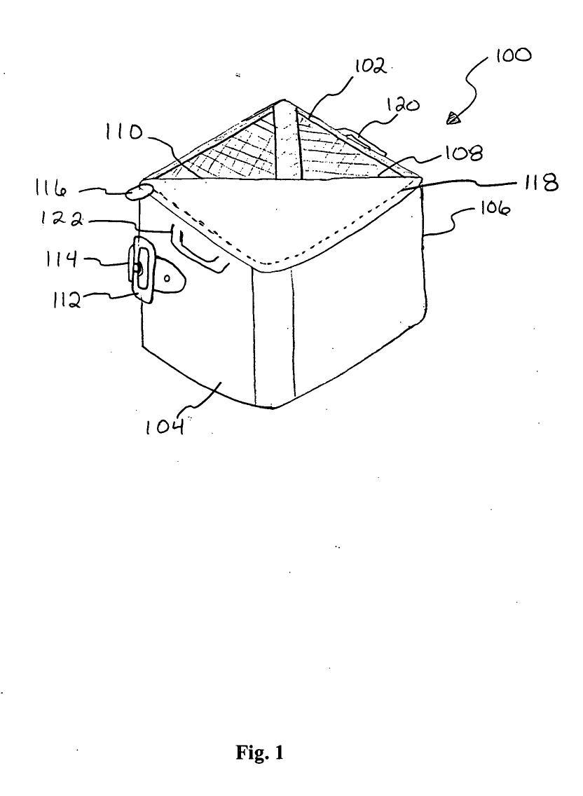

Referring initially to FIG. 1, an adjustable storage device 100 is shown that includes a first triangular volume 102 and second triangular volume 104. The first triangular volume 102 and second triangular volume 104 are operatively interconnected by a hinging member 106. In one embodiment, the first triangular volume 102 is an open top volume and the second triangular volume 104 is selectively closable. A cover of the second triangular volume 104 is sealed with zipper 118 and a closure pull 116. Thus, the top of the second triangular volume 104 can be opened and closed to secure various items of different sizes. Having a closable top ensures that in the case of an accident no items will fly out of the closed storage volume. The advantage of an open-topped first triangular volume 102 is made such that the first triangular storage volume 62 can hold objects that are taller than the adjustable storage device 100.

As can be seen in FIG. 1, a latch 114 and buckle 112 secure the free ends of the first triangular volume 102 and second triangular volume 104 to form a cube or a rectangle volume, depending on the sizes of the triangles. A first adjoining surface 108 of the first triangular volume 102 can be selectively secured to a second adjoining surface 110 on the second triangular volume 104. The two triangular volumes face back-to-back to form the rectangular adjustable storage volume 100. In this particular closed rectangle embodiment the hinge 106 connects the one side of the first triangular volume 102 and the second triangular volume 104, while the latch and buckle 114 and 112 respectively connect the other ends of the first triangular volume 102 and the second triangular volume 104.

The connecting members, namely the latch 114 and the buckle 112, need not be a single latch as is depicted in FIG. 1. More specifically, one skilled in the art will appreciate that a plurality of latches, a hook and loop material, buttons, snaps, or any other securing mechanism may be employed to selectively connect the free end of first triangular volume 102 with the free end of second triangular volume 104. These securing mechanisms can also serve to connect the adjustable storage volume 100 to the interior of the vehicle which would help ensure that the adjustable storage volume 100 does not become a dangerous projectile in the case of an accident.

Even though one triangular volume is open and the second triangular volume is closed in the depicted drawings, alternative embodiments could have both the first triangular volume 102 and the second triangular volume 104 be open or closed, or any combination thereof. Additionally, the first triangular volume 102 and the second triangular volume 104 can be made of a resilient material such that if any person impacted the adjustable storage volume 100 they would not suffer a serious injury.

In another alternate embodiment, pockets 128 can be placed inside or outside either the first triangular volume 102 or the second triangular volume 104 to provide further storage and organization. These pockets 128 can be made of a mesh or transparent material so that users can readily identify objects that are within the pocket or they could also be made of a solid, non-transparent material as well.

In another embodiment of the invention, the first triangular volume 102 has a first handle 120 and the opposite side of the second triangular volume 104 has a second handle 122 to facilitate easier lifting of the adjustable storage volume 100.

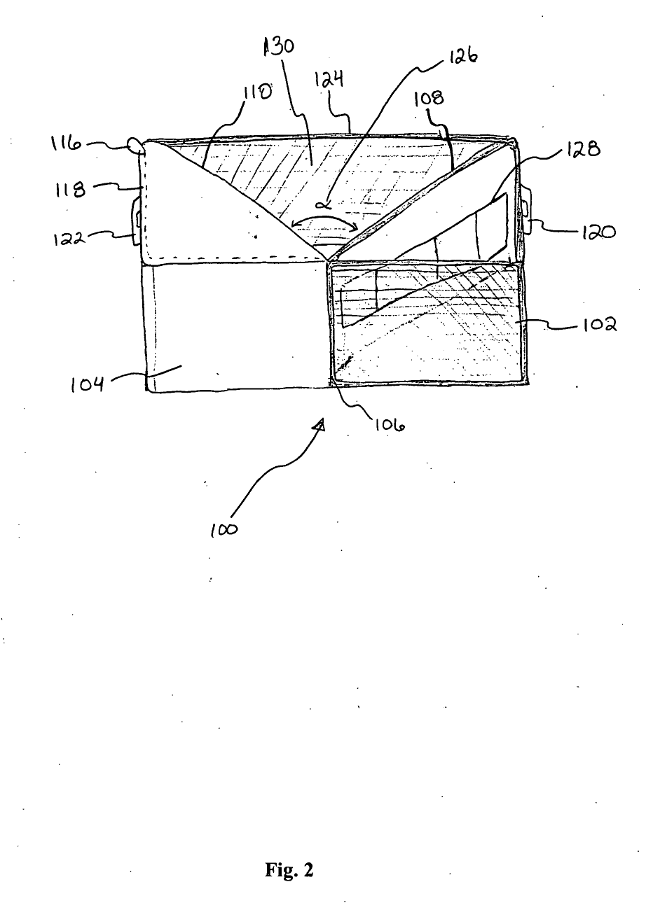

Now, with respect to FIG. 2, the adjustable storage volume 100 is shown in an open configuration thereby showing the dynamic storage capabilities of the present invention. The first triangular volume 102 and the second triangular volume 104 can be set to form a larger rectangle than was created in the first closed embodiment as can be seen in FIG. 1 by setting an angle α 126 between the first adjoining surface 108 and the second adjoining surface 110 between about 0° and about 180°. In this particular embodiment a first triangular storage cavity 130 is created between the first triangular volume 102 and the second triangular volume 104. An enclosing surface is provided that spans the distance across the first triangular cavity 130 between the first adjoining surface 108 and the second adjoining surface 110, thereby creating additional storage space. This open triangular cavity 130 thus facilitates further storage of various items whether it be toys, tools, cleaning equipment, office supplies, etc.

The enclosing surface 124 can be a mesh or transparent material allowing a user to easily see the items that are stored within the first triangular storage cavity 130. The enclosing surface 124 can also be a solid conformable material for added storage strength.

Also, the enclosing surface 124 could be a rigid material providing additional storage rigidity for the first storage cavity 130.

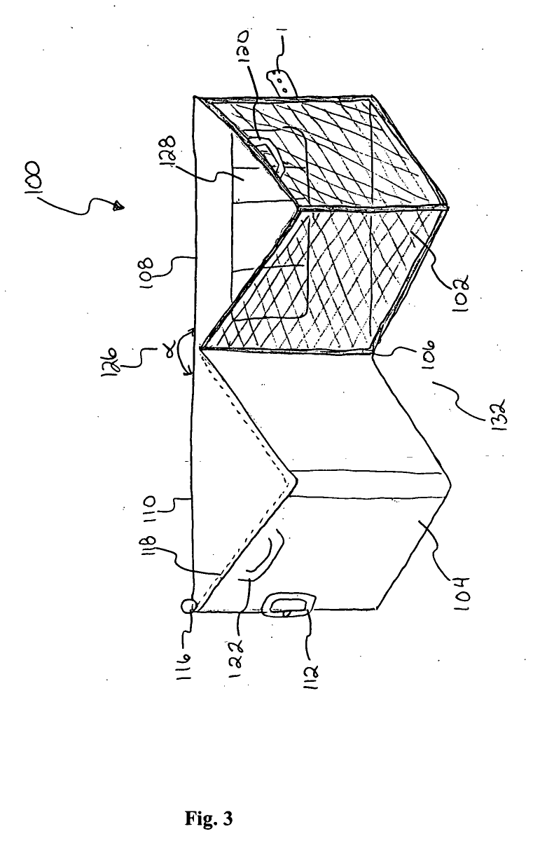

Referring now to FIG. 3 a further open configuration of the adjustable storage volume 100 is depicted. In this embodiment the angle 126 between the first adjoining surface 108 and second adjoining surface 110 is set to substantially 180°. Having the two triangular volumes configured in this manner allows the user to place the first and second adjoining surfaces 108 and 110, respectively, against a wall or flat surface. This embodiment also creates a second triangular cavity 132 between the first and second triangular volumes 102 and 104. The second triangular cavity 132 may also employed an enclosing material to create a more secure storage space. Alternatively, the outside face of the first triangular volume 102 and the opposing face of the second triangular volume 104 may be placed against two walls that come together in a corner. Doing so will result in turning the second triangular storage cavity 132 into a rectangular storage cavity.

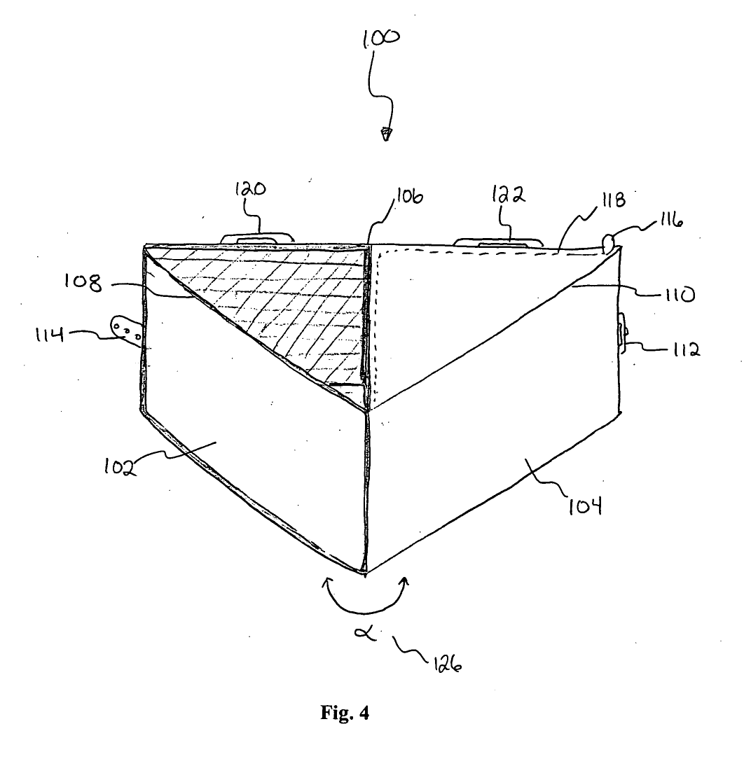

FIG. 4 depicts a further configuration of the present invention. In this particular embodiment the angle α 126 between the first adjoining surface 108 and the second adjoining surface 110 is greater than about 180°. Two of the previously free ends of the triangular volumes are now engaged to create yet another triangular configuration. This triangle is another dynamic adaptation of the adjustable storage volume 100 and allows further adaptability for storage use in various areas.

In varying configurations of the present invention the angle α 126 can vary from about 0° to about 270° in order to provide a dynamic storage device.

The advantage of being able to easily transition the same storage mechanism from a triangle to a rectangle is that it can easily adapt to whatever situation the user requires of it. A further advantage of the present invention is that it can be put in a corner as a triangle for a unique laundry hamper. Beyond laundry or utility, the disclosed storage device may also be used for closet storage or as storage for children's toys, etc. The invention need not be limited to the trunk of a car or the bed of a truck. However, the pockets created by the first triangular volume 102 and the second triangular volume 104 offer a good way of securing items in a moving vehicle.

In yet another embodiment of the present invention the first triangular volume 102 and/or the second triangular volume 102 and/or the second triangular volume 104 could be made of an insulating material. The adjustable storage volume could be used as a cooler with either rigid or compliant insulated surfaces.

It should also be understood that the present invention need not be limited to two storage volumes. A further embodiment of the present invention would be to combine one or more of the above described storage devices to expand the dynamic storage space from two storage volumes to a plurality of storage volumes. The inventions could be connected such that an accordion type storage device is created that can take on multiple forms beyond what was described above. The description was limited to two storage volumes for ease of understanding, but the invention should not be limited to just two storage volumes making a dynamic storage device.

One skilled in the art will appreciate that embodiments of the present invention may be collapsible. This feature creates another level of adaptability for the adjustable storage volume 100. For example, if a user only needs one triangular volume of storage then the opposite unused side can be collapsed such that no additional space is occupied by the adjustable storage volume 100. The storage space size can be adjusted to provide customized storage solutions. In addition, if there is no current need for storage then both triangular volumes 102 and 104 can be collapsed. This allows the user to store the adjustable storage volume 100 under a seat or in their garage and no unnecessary space is occupied.

Referring now to FIGS. 1-4, a brief description of a method of manufacturing one embodiment of the present invention is shown and described. More specifically, one skilled in the art will appreciate that the storage devices as described herein may be constructed of a rigid or a compliant material depending on the desires of the individual. Compliant materials such as leather, koskin, rubber, nylon, alone or in combination with selectively placed members for rigidity may be employed. Rigid materials such as plastics, cardboard, etc. may be also employed either alone or in combination with the previously described compliant materials. In addition, one skilled in the art will appreciate that common manufacturing techniques, such as sewing, heat welding, etc. may be employed to fabricate embodiments of the present invention as described herein.

While the present invention has been illustrated by description of preferred embodiments and while the illustrative versions have been described in considerable detail, it is not the intention of the inventors to restrict or in any way limit the scope of the appended claims to such detail. Additional advantages and modifications will readily appear to those skilled in the art upon reading this detailed description. Therefore, the invention, in its broader aspects, is not limited to these specific details, respective apparatus and methods, and illustrative examples shown and described. Accordingly, departures may be made from such details without departing from the spirit or scope of the inventor's general inventive concepts.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A flexible folding storage device, comprising:
a first volume defined by three generally vertical faces interconnected to form a prismatic shape having three vertical edges;
a second volume defined by three generally vertical faces interconnected to form a prismatic shape having three vertical edges, wherein an edge of said three vertical edges of said second volume is hingedly interconnected to an edge of said three vertical edges of said first volume; and
wherein an angle is formed between a face of said three generally vertical faces of said first volume and a face of said three generally vertical faces of said second volume said first volume and said second volume may be selectively oriented relative to each other to provide selective customization.

2. The storage device of claim 1, wherein said angle is between about 0° and about 270°.

3. The storage device of claim 1, wherein said angle is about 0°, wherein said first volume and said second volume form a rectangular storage volume.

4. The storage device of claim 1, wherein said angle is between about 0° and about 180° and a triangular storage cavity is provided between said first volume and said second volume.

5. The storage device of claim 4, further comprising an enclosing member that spans between said first volume and said second volume to enclose said triangular storage cavity.

6. The storage device of claim 1, wherein said angle is about 180° and wherein said first volume and said second volume form a plurality of triangular storage volumes.

7. The storage device of claim 1, wherein said angle is about 270° and wherein said first volume and said second volume form a triangular storage volume.

8. The storage device of claim 1, further comprising handles positioned on at least one of said generally vertical faces of said first volume and at least one of said generally vertical faces of said second volume.

9. The storage device of claim 1, further comprising pockets on at least one of said first volume and said second volume.

10. The storage device of claim 1, wherein at least one of said first volume and said second volume are selectively enclosed.

11. The storage device of claim 10, wherein at least one of said first volume and said second volume are selectively enclosed by a zipper.

12. The storage device of claim 1, further comprising a securing member that is at least one of (i) capable of selectively interconnecting said first volume to said second volume in a selected orientation and (ii) adapted to interconnect said storage device to an external object.

13. A flexible folding storage device, comprising:
a first storage volume comprising at least:
a first edge;
a second edge; and
a first face interconnecting said first edge and said second edge;
a second storage volume comprising at least:
a third edge;
a fourth edge; and
a second face interconnecting said third edge and said fourth edge; and
wherein said first edge of said first storage volume and said third edge of said second storage volume are hingedly interconnected, and wherein said first and second storage volumes are selectively oriented relative to each other such that an angle is formed between said first face and said second face.

14. The storage device of claim 13, wherein said angle is between about 0° and about 270°.

15. The storage device of claim 13, wherein at least one of said first storage volume and said second storage volume are a triangular storage volume.

16. The storage device of claim 13, wherein said angle is about 0°.

17. The storage device of claim 13, wherein said angle is about 180°.

18. The storage device of claim 13, wherein said angle is about 270°.

19. The storage device of claim 13, further comprising handles positioned on at least one of said first storage volume and said second storage volume.

20. The storage device of claim 13, further comprising pockets on at least one of said first storage volume and said second storage volume.

21. The storage device of claim 13, wherein at least one of said first storage volume and said second storage volume are selectively enclosed.

22. The storage device of claim 21, wherein at least one of said first storage volume and said second storage volume are selectively enclosed by a zipper.

23. The storage device of claim 13, further comprising a securing member that is at least one of (i) capable of selectively securing said first storage volume and said second storage volume in a selected orientation and (ii) adapted to interconnect said storage device to an external object.

24. A flexible folding storage device, comprising:
a first means for storage comprising at least:
a first edge;
a second edge;
a first face connecting said first edge to said second edge;
a second means for storage comprising at least:
a first edge;
a second edge;
a first face connecting said first edge to said second edge;
a hinging means for connecting said first edge of said first storage means to said first edge of said second storage means; and
wherein said first storage means and said second storage means are selectively oriented relative to each other such that an angle is formed between said first face of said first storage means and said first face of said second storage means.

25. The storage device of claim 24, wherein said angle is between about 0° and about 270°.

26. The storage device of claim 24, further comprising means for lifting said storage device, wherein said means for lifting are positioned on at least one of said first storage means and said second storage means.

27. The storage device of claim 24, further comprising pockets that are interconnected to at least one of said first storage means and said second storage means.

28. The storage device of claim 24, wherein at least one of said first storage means and said second storage means are selectively enclosed.

29. The storage device of claim 24, further comprising a means for securing that is at least one of (i) capable of selectively securing said first storage means and said second storage means in a selected orientation and (ii) adapted to interconnect said storage device to an external object.
